(19) United States
(12) Patent Application Publication
(10) Pub. No.: US 2014/0257855 A1
(43) Pub. Date: Sep. 11, 2014

(54) SYSTEM AND METHOD FOR PROVIDING A MULTI-MODALITY DEVICE WITH ABSTRACTION LAYER SUPPORT FROM A HEALTHCARE PLATFORM

(71) Applicant: Verizon Patent and Licensing Inc., Arlington, VA (US)

(72) Inventor: Allen MOORE, Florence, AL (US)

(73) Assignee: Verizon Patent and Licensing Inc., Arlington, VA (US)

(21) Appl. No.: 14/202,857

(22) Filed: Mar. 10, 2014

Related U.S. Application Data
(60) Provisional application No. 61/776,471, filed on Mar. 11, 2013.

(51) Int. Cl. G06F 19/00

(52) U.S. Cl. CPC G06F 19/3418
USPC 705/3; 705/2

(57) ABSTRACT

An approach is provided for a multi-modality device including an abstraction layer supported by a healthcare platform. The approach includes providing an abstraction layer for a processing, a collection, or a combination thereof of one or more modalities of health sensor data sensed by a multi-modality device associated a first party. The approach also includes initiating a communication session between the multi-modality device associated and a device associated with a second party for transmitting the health sensor data, selecting the one or more modalities, configuring the multi-modality device to support the one or more modalities, providing health diagnostic information based on the health sensor data, or a combination thereof.

### RELATED APPLICATION

This application is a continuation of U.S. Application Ser. No. 61/776,471, titled “Multiple Clinical Modality Data Capture Tool Used by a Patient to Interact with a Distant Health Professional During or Prior or Post a TeleHealth Encounter to Send Patient Data to a Clinician,” filed on Mar. 11, 2013, the entirety of which is incorporated herein by reference.

### BACKGROUND INFORMATION

Access to healthcare can result in measurably better outcomes for a population. Telehealth improves the quality of healthcare for many though greater immediate access by delivering health-related services and information using telecommunication technologies. However, current implementations of telehealth are limited. For example, remote patients do not have access to tools that would allow a telehealth patient to provide the range of traditional clinical data to remote staff. There are no multi-modality adaptable devices available in the public domain which can replicate clinical tools used during a traditional same space visit with a clinician during a health visit. Therefore, there is a need for providing multi-modality devices with support from an abstraction layer from a healthcare platform.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing multi-modality devices with support from an abstraction layer from a healthcare platform, according to one embodiment;

FIG. 2 is a diagram of the healthcare platform, according to one embodiment;

FIG. 3 is a flowchart providing multi-modality devices with support from an abstraction layer from a healthcare platform, according to one embodiment;

FIG. 4 is a flowchart of a process for retrieving database information for parties in the telehealth sessions, and providing and/or communicating instructions for configuring combinations for synchronous and asynchronous telehealth sessions, according to one embodiment;

FIG. 5 is a flowchart of various features of a multi-modality device within a healthcare platform network, according to one embodiment;

FIG. 6 is a diagram of an embodiment of a multi-modality core device and possible options for modalities, according to one example embodiment;

FIG. 7 is a diagram of an implementation of the central controlling hand piece engaged in a communication session with a second party, according to one example embodiment;

FIG. 8 is a diagram for an example workflow using the multi-modality device during a communication session, according to one embodiment;

FIG. 9 is a flow chart for an implementation of the use of the multi-modality device during a communication session, according to one embodiment;

FIG. 10 is an image of a sample implementation of a multi-modality device, according to one embodiment;

FIG. 11 is a diagram of a computer system that can be used to implement various exemplary embodiments; and

FIG. 12 illustrates a chip set 1200 upon which an embodiment of the invention may be implemented.

### DESCRIPTION OF THE PREFERRED EMBODIMENT

An apparatus, method, and software for providing multi-modality devices with support from an abstraction layer from a healthcare platform, is described. In the following description, for the purposes of explanation, numerous specific details are set forth in order to provide a thorough understanding of the present invention. As is well known, the present invention may be practiced without these specific details or with an equivalent arrangement. In other instances, well-known structures and devices are shown in block diagram form in order to avoid unnecessarily obscuring the present invention.

Although the various exemplary embodiments are described with respect to providing consumer accessible multi-modality devices with support from an abstraction layer from a healthcare platform, it is contemplated that these embodiments have applicability to monitoring any other type of communications network that supports communication between multiple parties (e.g., calling party and called party), whether or not the parties are part of a healthcare network.

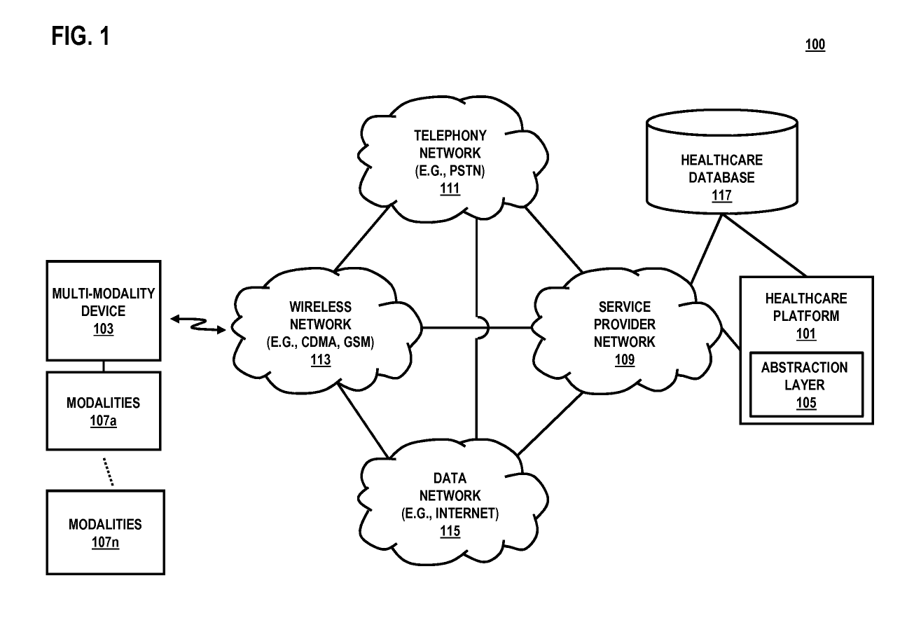

FIG. 1 is a diagram of a system capable of providing multi-modality devices with support from an abstraction layer from a healthcare platform, according to one embodiment. A communication session may consist of any health-related services and information exchange utilizing telecommunication technologies. For example, a communication session is a communication session that can vary from health professionals discussing a case over a network to robotic surgery from different parts of the world. For example, telehealth is one type of communication session and may encompass preventative, promotive, and curative technological solutions to medicine. While telehealth improves the quality of healthcare for many though greater immediate access, current implementations of telehealth are limited. For example, remote patients, whether synchronous or asynchronous, lack the tools necessary to provide the range of traditional clinical data to remote healthcare staff. For instance, remote patients cannot access multi-modality adaptable tools available in the public domain capable of replicating clinical tools used during a traditional same space visit with a clinician during a health visit.

Telehealth is limited by current implementations of clinical tools. Currently, clinical tools are designed to be in clinical settings, and not in the public domain. Clinical tools are limited in their modality. For example, the electronic stethoscope is singular in its purpose and no part of it can be adapted to measure temperature or blood pressure. Additionally, clinical tools are not available to the masses. Even if clinical tools were available to the masses, clinical tools may not be usable by the public as clinical tools are not intuitive. Existing clinical tools are designed to present data locally. Existing clinical tools are also purposed for a single modality for use in same space clinical settings. Therefore, for each modality there is a need for a unique tool. Existing single modality tools are too complicated to be effective when in the hands of the remote patient or lay-professional.

To address this problem, the system in FIG. 1 introduces the capability for a healthcare platform 101 (hereinafter HP 101) to provide consumer accessible multi-modality device 103 (hereinafter devices 103) within the system 100. The system 100 provides for a patient friendly clinical tool with optional interchangeable clinical interfaces. The communication session data may then be shared via multiple interchangeable communication interfaces. In an exemplary embodiment, the system 100 allows a remote practitioner (e.g., first party) to consult with a patient (e.g., second party) using a combination of public domain technology and service specific tools. Additionally, the system 100 may be implemented in any situation wherein a multi-modality device associated with a first party engages in a communication session with a device or devices associated with a second or multiple parties for transmitting health sensor data. Thus, the system 100 may help complete the communication session for a more meaningful diagnosis. Also, the system 100 can produce data to populate clinical health data records and improved health outcomes.

The system 100 supports the device 103 with abstraction layer 105, compatible with interchangeable modalities 107a-107n (hereinafter adapters 107). These adapters 107 may serve clinical and/or communication roles when affixed to the device 103 to form a multi-modality device 103. That is, these modalities 107 may be different sensors or communication modes or adapters. The healthcare platform 101 and abstraction layer 105 then serves as a way to mediate, normalize, interpret, etc. data captured by the device. Communication session data may be any data or metadata collected or shared during a communication session. The communication session data may be collected, processed and/or shared using these adapters 107 in combination with the device 103. The system 100 supports a scenario wherein a remote practitioner may consult with a patient using a combination of public domain technology (e.g., service provider network 109, telephony network 111, wireless network 113, and/or data network 115, hereinafter networks 109-115) and service specific tools. The system 100 helps to complete the communication session for a more meaningful diagnosis by allowing the patient access to the tools necessary to collect a broad range of clinical data and allowing the clinician greater access and control of the data available from a communication session, thereby creating a virtual community. A patient may be one or more individuals seeking health care services and a clinician or practitioner may be one or more individuals who provide healthcare services to the said patient in the form of a physical examination, diagnosis, treatment, etc.

In an exemplary embodiment, the first logic gate is determined during the communication session. A communication session may or may not demand the use of the device 103. A clinical engagement during a communication session will determine if the device 103 is necessary for the consultation or not. If the communication session (hereinafter, session) is such that the consult alone may produce a course of treatment, the patient visit may be concluded without the use of the device 103. The second logic gate is found in the assessment phase of the session. If it is found the device 103 is needed, the clinician will advise the patient on which clinical interface adapter is necessary and instruct on its use. To illustrate this gate; when the device 103 is required during the session, the device 103 is not limited to but could take a temperature through a thermal adapter and relay that data to the clinician. Subsequently upon instruction from the remote clinician the patient may exchange the active adapter for one which may provide magnified illuminated optics to view the surface of or into the body. Locale and communication interface choices provide a third gate. If the patient is near a connected computing device he may choose a wired connection or wireless connection interface for the device 103. Another choice allows the device 103 to be autonomous by using wireless network 113 for connections, or further connect via a medium or directly to satellite or telephony network 111. The fourth gate is indicated by the process to send and interact during a remote but interactive same time session using live session data or to allow the patient to store their patient data in the on board memory for transmission at a later time or as trending data. Any of these steps taken after the initial telehealth engagement offers remote clinicians the opportunity to quantify the clinical data of the patient session.

For example, in step 801, a patient in a communication session with a clinician may start by connecting to the HP 101 and then in step 803, engaging in a clinical session. In step 805, the patient may then assemble or connect the device 103 to communicate with the remote clinician followed step 807, where the patient may assemble or connect the appropriate clinical interface to the tool. In step 809, the patient may use the device 103 as directed during the session before step 811, where the clinician may review the data sent by the device 103. In step 813, if additional diagnostics are needed to exchange adapters (as many times they are needed), before step 815 where a clinician may review the additional data sent by the device 103. In step 817, information may be sent from the remote clinician to the device 103. Finally, in step 819, the device 103 may be used for future clinical data autonomously.

As shown, the system 100 includes an HP 101 implemented as, for example, part of a service provider network 109. However, in alternative embodiments, the HP 101 could be implemented as any part of the system 100, including non-healthcare networks. The HP 101 is associated with the healthcare database 117 (hereinafter, database 117), which may be any on or off-site database that may store information for all parties within the communication session such as patient information, user profile information, information about registered devices 103, healthcare provider registration information, healthcare provider created health records, clinician profile, clinician's diagnostic notes, prescription history, telehealth appointments, etc. In one embodiment, the service provider network 109 can interact with one or more other networks, such as a telephony network 111, a data network 115, and/or a wireless network 113.

In one embodiment, the HP 101 may utilize the communication session participants' former communication sessions to provide instructions or configure the first interface. For example, the HP 101 may ascertain from the database 117 that the current user, Bill's, last three sessions involved a wired connection from his home address. The HP 101 may prompt Bill to re-establish this same connection by directing Bill to attach the wired communication interface adapter 107 to the device 103's communication interface. In another embodiment, if the HP 101 detects that the wired communication interface adapter 107 is already attached to the device 103, then the HP 101 may automatically prompt Bill to re-establish the former connection.

In another embodiment, the multi-modality device 103 may asynchronously dispatch batches of captured sensory data to the HP 101. For example, continuing with the example of Bill above, Bill's device 103 and thermo-reader adapter 107 may be programmed to transfer the data collection from the multi-modality device 103, or a set of data from affixing various modalities 107, before dispatching the data set for batch transmission.

In another embodiment, the clinician or the HP 101 may be alerted to collect sensor data from a different multi-modality device 103 based on previously captured data from a previous multi-modality device 103. For example, continuing with the example with Bill above, the HP 101 may detect that the patient's temperature is in the range for a fever. Based on this data, the HP 101 may automatically prompt Bill to take images of his throat to determine if he has a sore throat or cough accompanying his fever. Similarly, a clinician may ask a patient to submit blood pressure readings using a multi-modality device 103 after hearing a high heart rate. Additionally, the clinician may remotely control the multi-modality device 103 formed into a sphygmomanometer-like apparatus to take blood pressure readings. That is, the clinician may remotely control the multi-modality device 103 over the communication session.

In another embodiment, the HP 101 may create a patient health record within database 117, locally at device 103 or on the device 103's removable storage, or a combination based on the health sensor data collected from the multi-modality device 103. For example, continuing with the above example with Bill, if Bill were a new patient, the HP 101 may create a new patient health record using the captured data from the various multi-modality device 103 sensor health readings in his first telehealth session within HP 101. If Bill returned for another telehealth evaluation, the HP 101 may add to this initial record of Bill's first telehealth session. In another embodiment, Bill's patient health data may be shared if he changes healthcare providers, visits a specialist who would like to refer to his previous lab work, etc. In another embodiment, Bill's patient health record may be anonymously pulled to determine trends in healthcare and create other forms of aggregated data from a multitude of patients across various healthcare networks.

In one embodiment, the healthcare database 117 can be associated with any part of the system 100, such as with the telephony network 111, the data network 115 and the wireless network 113. Additional services associated with, for example, the telephony network 111, the data network 115 or the wireless network 113, also can interact with the HP 101, and the healthcare database 117. By way of example, a healthcare provider associated with the data network 115 can store healthcare information in one or more healthcare databases 117 associated with the service provider network 109.

For illustrative purposes, the networks 109-115 may be any suitable wireline and/or wireless network, and be managed by one or more service providers. For example, the telephony network 111 may include a circuit-switched network, such as the public switched telephone network (PSTN), an integrated services digital network (ISDN), a private branch exchange (PBX), or other like network. The wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 115 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of the system 100. In this manner, networks 109-115 may embody or include portions of a signaling system 7 (SS7) network, or other suitable infrastructure to support control and signaling functions.

In an exemplary embodiment, the multi-modality device 103 is made by incorporating multiple adapters 107 into a user friendly patient self-administering controlling device 103 which provides clinical data to a remote clinician via networks 109-115 during a communication session. The device 103 provides clinicians a range of clinical patient data from a single multi-modality device 103. This device 103 uses a modular modality patient interface to capture a range of clinical data. Interfaces may be exchanged by the remote patient depending on the diagnostic session. This patient data promotes a more qualified remote diagnosis. According to one embodiment, the device 103 is a light weight hand piece core, accommodated by the general public, offers multiple clinical modalities through multiple interface options which attach directly to the core device 103 and offers multiple methods of connecting healthcare providers and patients. The device 103 may interchange its clinical interfaces, it is intended to be used by patients and care givers during a communication session to aid the remote healthcare professional's clinical observations. The patient/care-givers hands become an extension of the remote clinician hands. According to one embodiment, the device 103 has on board energy, can be externally powered, provides for non-volatile and removable storage, self-contained communications provisions, and can interface for a wired or wireless communication session.

The device 103 closes the gap between same space clinician to patient sessions and communication sessions by offering patient data to the remote clinician in much the same way the clinician would find in a same space session. The session is more meaningful when the clinicians can quantify symptoms by using the device 103 herein. The device 103 is comprised of four modules: a communications interface (CI), a central controlling hand piece (C), clinical interface adapters (CM), and the application interface (AP). The AP provides the data path during the session between clinician and patient. In one embodiment, this AP data path may travel from the device 103 to the HP 101 and the abstraction layer 105 back to the device 103. Ideally, the unit collects the CM patient data which is passed toward or interpreted to the C which collects and stores or collects and forwards the data out the CI for treatment interpretation using the AP. Any data sent from the clinician toward C would also use the AP. The AP session data will be sent between two known devices using a common security protocol.

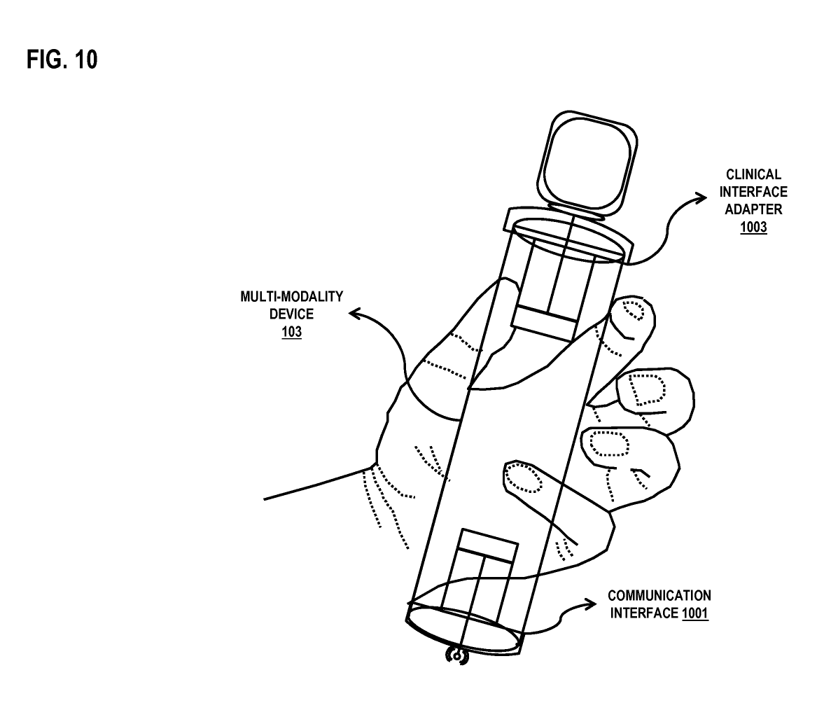

The device 103 may be made by incorporating multiple modular clinical modality collection interfaces into a user friendly patient self-administering controlling device 103 which provides clinical data to a remote clinician via multiple communications methods during a communication session. In an exemplary embodiment, the device 103 may take the form of a cylinder small enough to be manipulated by a patient (see FIG. 10). The cylinder may provide a receiving and securing means at each pole for communication interfaces and the clinical modality collection interfaces. The interfaces themselves may mate the appropriate pole and also provide a means of securing onto the device 103. The interfaces may be intuitive in their design and common in their form factor. Some collection devices 103 may offer immediate onboard feedback. A generalized interface may be used as a medium between the core device 103 and any ancillary clinical collector.

When clinical patient data is necessary during a communication session the device 103 may be a useful tool. Each of the adapters 107 may be interchanged with the device 103. Additionally, each of the adapters 107 may be interchanged given the locale. In one embodiment, the device 103 may be assembled with a single modality interface collector adapter 107 and a single communications pathway adapter 107 to operate. On board storage is needed for patients wanting to transmit their data asynchronously. On board energy is needed to allow the unit to work alongside other stored energy devices. The additional modalities may be added based on the patient's desire, clinical need, or technology available at a locale. A secure wide area means of communications is needed during the session. Other communication interfaces may be provided for as technology matures and changes. The application interface is necessary to provide the patient a communication platform to a remote clinician. The device 103 may welcome additional data collection elements or treatment pathways which enhance the outcomes.

The HP 101 provides patient relevant clinical data in the patient's setting to a remote clinician. Any juxtaposition of the invention elements which continue to collect and report or provide or exchange clinical data for treatment action plans or enhanced telehealth experience may still function as the device 103 is intended. According to one embodiment, the device 103 may select from a number of communication adapters but only one may be affixed to the device at a time. According to one embodiment, the device may select from a number of clinical interface collectors but only one may be affixed to the device at a time.

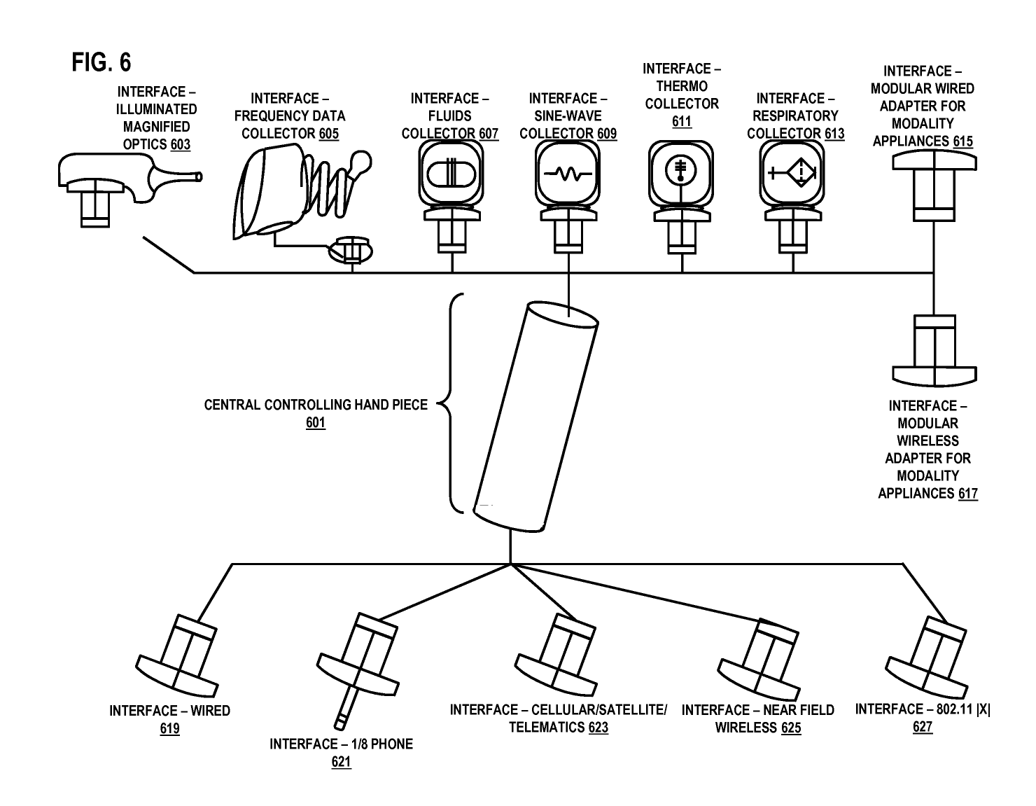

For example, Gina lives in rural Alaska and her nearest health clinic is several hundred miles away. Additionally, the weather conditions would make the half-day trip to the clinic a treacherous one. However Gina has sustained a cough that has persisted for an unusually lengthy period of time and Gina would like to seek the opinion of a clinician. Gina may go online or to a nearby drugstore, which may be much closer than the health clinic, to purchase the device 103 and several of its modalities 107. Gina may then make a telehealth appointment. Right before her appointment time, Gina may connect her device 103 to wireless network 113 to connect with the HP 101 and sign into the telehealth session. If Gina was a previously registered patient, the HP 101 may retrieve Gina's information from the healthcare database 117. Once she is signed into HP 101, Gina may assemble or connect the device 103 to communicate with the remote clinician. For example, Gina may attach the cellular/satellite/telematics interface adapter 107 (see FIG. 6) to the device 103 to establish a communication session with the remote clinician via the HP 101.

Once her session starts, the remote clinician may instruct Gina to attach the thermo collector modality 107 (see FIG. 6), creating multi-modality device 103, which may measure and send her temperature to the clinician. Multi-modality device 103 may transmit the data collected to the clinician using the wireless network 113 and the connection established by the cellular/satellite/telematics interface adapter 107. Upon receiving this data, the clinician may make note of and/or save the data before instructing Gina to attach the illuminated magnified optics modality 107 (see FIG. 6), creating another instance of multi-modality device 103. Once the multi-modality device 103 transmits the images collected of Gina's throat using the connection and interface adapter mentioned above, the clinician will be able to see these images of Gina's throat. The session may continue until the clinician has collected the data she needs to assess Gina's cough.

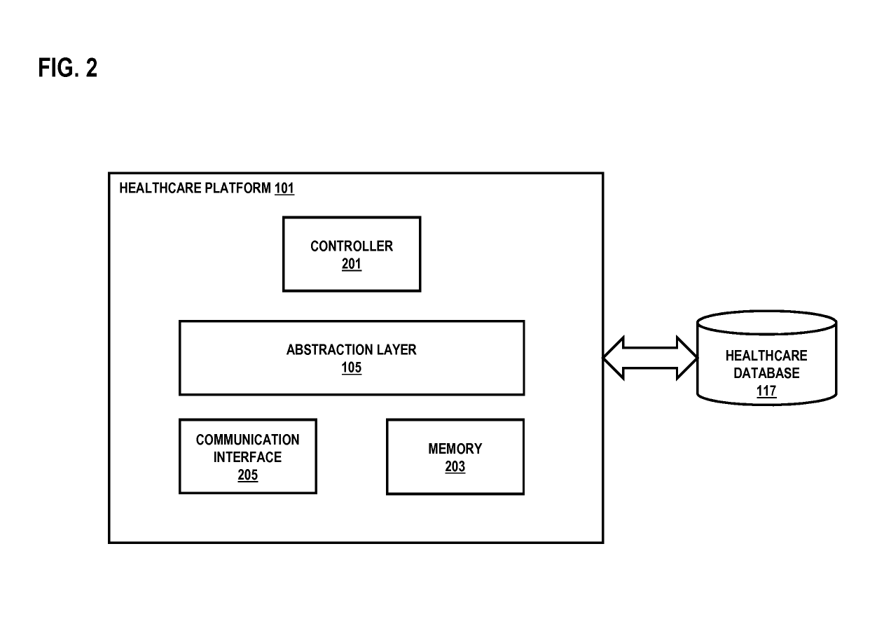

FIG. 2 is a diagram of the healthcare platform 101, according to one embodiment. Although illustrated as a separate element with respect to a service provider network 109 within the system 100, the HP 101 may alternatively be embodied in, for example, the device 103 or connected to another one of the networks 109-115. In one embodiment, the HP 101 contains an abstraction layer 105, controller 201, communication interface 205, and memory 203. The HP 101 may communicate with the healthcare database 117 to retrieve the user profile information, user health record, user's registered devices, telehealth appointment history, clinician profile, clinician's former notes, etc.

The abstraction layer 105 serves as a way to mediate, normalize, interpret, etc. data captured by the device 103. The controller 201 performs control logic functions and facilitates coordination among the other components of the HP 101. In one embodiment, the communication interface 205 receives clinical data from the device 103 and this data may be stored within HP 101. The abstraction layer 105 may recognize the data as a temperature reading in degrees Celsius and the controller 201 stores the data in memory 203. Additionally, the abstraction layer 105 may detect that the communication interface 205 data is received from a wired connection. The abstraction layer 105 may then mediate the temperature data so that this data may be ready for transfer by a wired connection via the communication interface 205. If the patient removes the thermo collector adapter 107 and replaces it with modality 107 for measuring blood pressure, the communication interface 205 may take the pressure readings in mmHg, transmit the pressure readings to the abstraction layer 105 for transmission to the communication interface 205. In another example, a clinician may communicate instructions to the patient via the system 100. In this scenario, the communication interface 205 may receive and transfer the instructions to the abstraction layer 105. The abstraction layer 105 may receive the instructions and make the instructions readable by the device 103's speakers. In another embodiment, the HP 101 may federate the data across other healthcare platforms or pull the data from clinical decision support systems. For example, the temperature data received by the HP 101 may be combined with data from other HP 101 platforms that may serve different healthcare providers. In other embodiment, such combined data may be aggregated across multiple healthcare providers serviced by multiple HP 101's to determine trends and best practice responses to those healthcare trends via clinical decision support systems.

In one embodiment wherein an asynchronous mode of operation is in effect, the user may collect sensory data utilizing a frequency data collector modality 107, a sine-wave collector modality 107, and a respiratory collector modality 107. After the communication interface 205 receives data from each of these module adapters 107, the respective collected data may be transferred to the abstraction layer 105. The abstraction layer 105 may mediate the data for storage in memory 203 until a batch of data has been created for transmission using the communication interface 205.

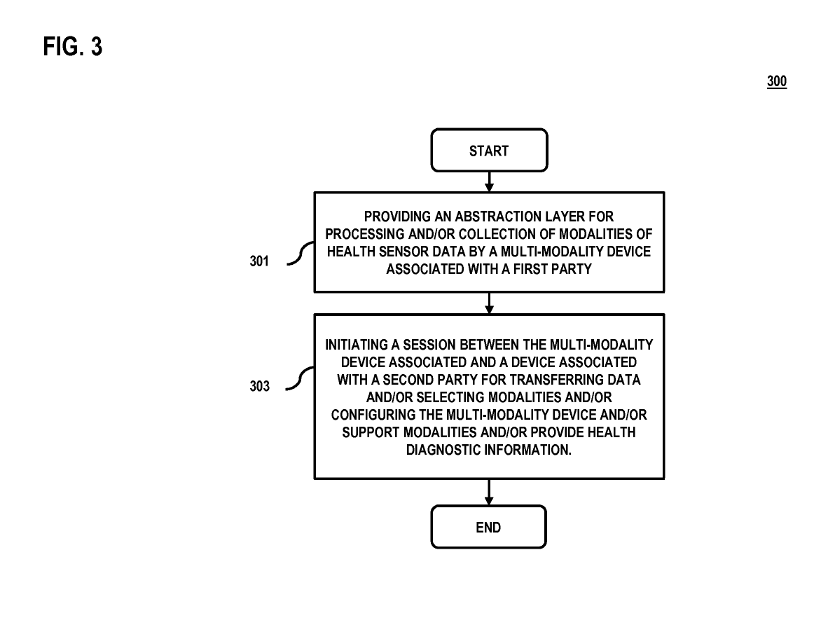

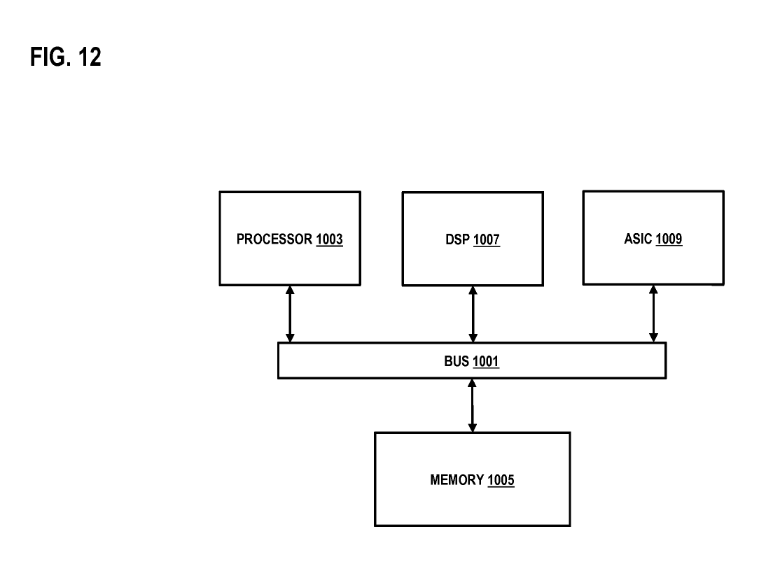

FIG. 3 is a flowchart providing multi-modality devices including an abstraction layer supported by a healthcare platform, according to one embodiment. By way of example, this authentication process is explained with respect to the HP 101, multi-modality device 103, and the healthcare database 117. In one embodiment, the HP 101 performs the process 300 and is implemented in, for instance, a chip set including a processor and a memory as shown in FIG. 12. Although FIG. 3 illustrates steps 301 through 303 in a particular order, the order and number of steps is merely for explanation, and one or more steps may be performed in a different order or removed.

In step 301, the HP 101 provides an abstraction layer for a processing, a collection, or a combination thereof of one or more modalities of health sensor data sensed by a multi-modality device associated at a first party, according to one embodiment. The abstraction layer 105 may consist of a hierarchy of abstraction levels that may be capable of breaking down specificities into generalities based on broad similarities from specific implementations. In other words, an abstraction layer 105 may distill a useful concept or metaphor for simple reuse in situations where it may be accurately applied and quickly recognized. The abstraction layer 105 in step 301 may collect health sensor data from a variety of modalities 107 capable of collecting a broad range of health sensors such as heart rate, blood pressure, temperature, respiratory health, blood sugar levels, and body fluid collection such as blood, urine, saliva, etc. The abstraction layer 105 may also process such sensory health data by distilling the data for transmission or processing the data in such a way that the data may be communicated via a variety of communication and/or modular interfaces. A multi-modality device 103 may be any device 103 capable of use with multiple modular adapters 107 and communicating within a network. A first party may be any person with access to a telehealth session using the device 103. For example, the first party may be a clinician, patient, caretaker, parent, child, etc.

In step 303, the HP 101 initiates a communication session between the multi-modality device associated and a device associated with a second party for transmitting the health sensor data, selecting the one or more modalities, configuring the multi-modality device to support the one or more modalities, providing health diagnostic information based on the health sensor data, or a combination thereof. A communication session may be any network connection involving at least two parties and their associated device 103. For example, Nancy and her son Garth may represent a first party and their device 103 is associated with their family's health profile. Garth is exhibiting some symptoms of a cold. Nancy establishes a wireless connection using her device 103 to the HP 101 and Garth's physician, Dr. Lee. In other embodiments, this wireless connection may utilize any of the networks 109-115. During the telehealth session, Dr. Lee may instruction Nancy to fit a number of modalities 107 to the device 103 in order to collect a range of sensory health data from Garth. Dr. Lee may retrieve this data from his own device 103 in order to diagnose Garth. Based on Garth's temperature, age, weight, height, and symptoms, Dr. Garth diagnoses Garth with a flu.

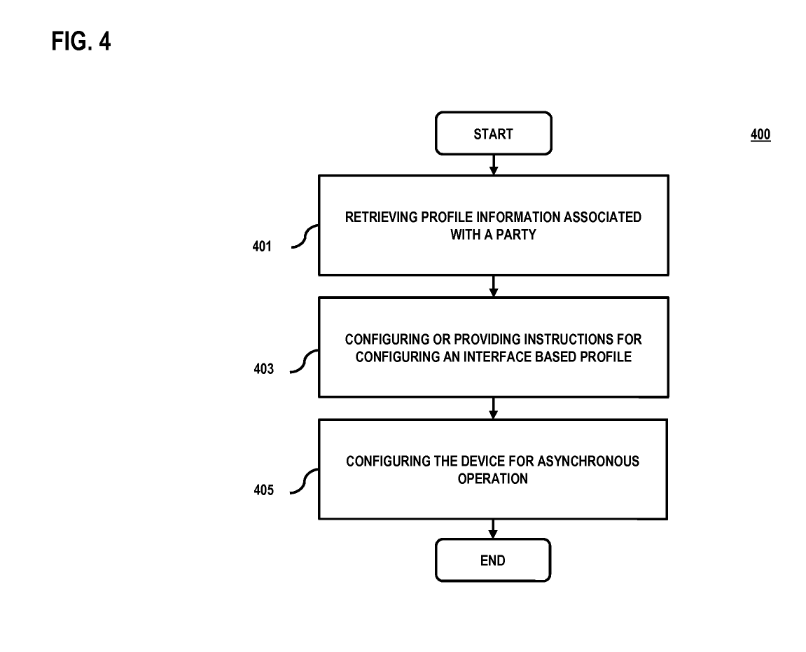

FIG. 4 is a flowchart of a process for retrieving database information for parties in the telehealth sessions, and providing and/or communicating instructions for configuring combinations for synchronous and asynchronous telehealth sessions. In one embodiment, the HP 101 performs the process 400 and is implemented in, for instance, a chip set including a processor and a memory as shown in FIG. 12. Although FIG. 4 illustrates steps 401 through 405 in a particular order, the order and number of steps is merely for explanation, and one or more steps may be performed in a different order or removed. In step 401, the HP 101 retrieves profile information associated with the first party, the second party, or a combination thereof. The profile information associated with one of the parties in a communication session may be found in the database 117 and/or the device 103. The profile information may consist of biographical information of a patient (name, address, age, occupation, location, etc.), health history (height, weight, family health history, former vital stats, allergies, current health complications, etc.), technical history (IP address, often utilized connections types, device 103 serial number, registered modalities 107, phone numbers, etc.) For a clinician, the profile information may include the clinician's practice specialties, insurance types accepted, practice groups, resume, office hours, vacation schedule, location, etc. For a healthcare provider, the profile information may include locations, insurance types accepted, privacy policies, hours of operation, list of clinicians, practice areas, etc. In another embodiment, the data may be captured as protected health information in the database.

In step 403, the HP 101 configures or provides instructions for configuring the first interface, the second interface, or a combination thereof based on the profile information. In one embodiment, the HP 101 may configure the first interface for communication with a communication modality 107 for both hardware and software interfaces based on the associated party's profile information. In another embodiment, when a patient and a clinician initiates a communication session, the HP 101 may collect the patient's biographical, health, and technology information as well as the clinician's and the healthcare provider, if the clinician is working directly under a healthcare provider. For example, the HP 101 may recognize that the database 117 records indicate that for previous telehealth sessions, the two parties in the communication session have collected and shared the patient's: temperature, heart rate, and blood pressure. Accordingly, the HP 101 may make predictive suggestions to the user regarding which clinical modality 107 to affix to the central controlling device 103. In another example, for a patient with a health profile indicating diabetes, the HP 101 may prompt the patient to configure a multi-modality device 103 that may accept fluids to measure blood sugar level upon logging on.

For example, for a particular patient, upon logging into the communication session, the HP 101 may prompt the clinician and/or the user to collect temperature, heart rate, and blood pressure. That is, the clinician may log into the session and the HP 101 may relay a message asking if the clinician would like the HP 101 to transmit instructions for the user to collect temperature. The clinician may select a canned set of instructions, edit one of the canned instructions, or create her own set of instructions to signal and instruct to the patient how to affix the thermo collector modality 107 to the device 103 and record his temperature. In another example, the HP 101 may directly prompt the user to collect his own temperature while waiting for the clinician to become active in the session.

In step 405, the HP 101 configures the multi-modality device for an asynchronous mode of operation. The HP 101 may configure the device 103 to synchronously or asynchronously transmit the collected sensory health data to a second party in the communication channel. The asynchronous transmission involves transferring batches of sensory data rather than transferring a steady stream of data as it is collected. For example, a patient's multi-modality device 103 including a frequency data collector modality 107 may be programmed to transfer the data collection from the current multi-modality device 103, or a set of data from multi-modality device 103's, before dispatching the data set for batch transmission. This type of data transmission is in contrast to a synchronous data transmission wherein the data is transferred in real time or near real time to the transferred party as the sensory data is received by the multi-modality device 103. In another example, parties within a communication session may opt for an asynchronous transfer mode if there are large transfers of data to be made when the network is experiencing heavy traffic volume.

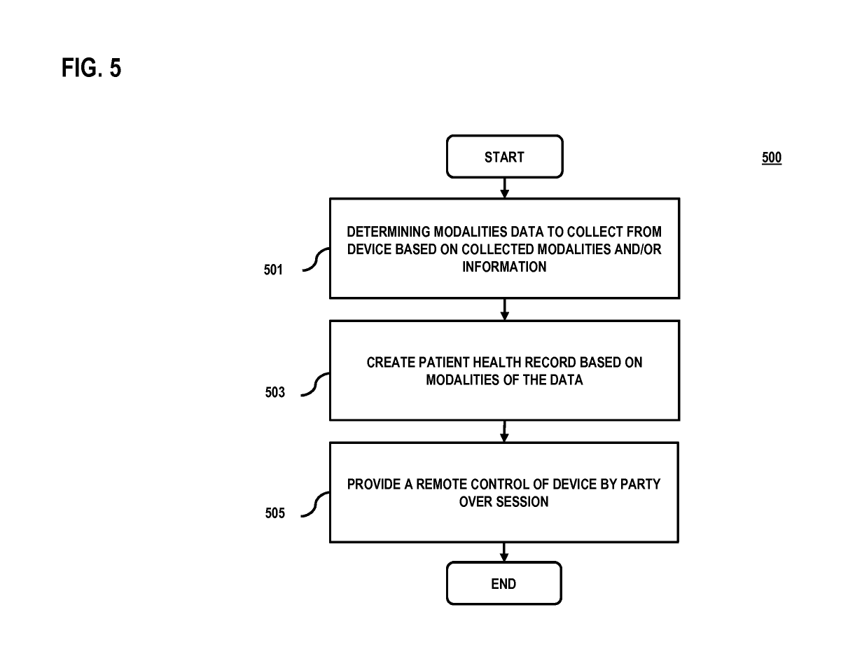

FIG. 5 is a flowchart of various features of a multi-modality device within a healthcare platform network, according to one embodiment. In one embodiment, the HP 101 performs the process 500 and is implemented in, for instance, a chip set including a processor and a memory as shown in FIG. 12. Although FIG. 5 illustrates steps 501 through 505 in a particular order, the order and number of steps is merely for explanation, and one or more steps may be performed in a different order or removed. In step 501, the HP 101 determines one or more other modalities of the health sensor data to collect from the multi-modality device based on the collected one or more modalities, the health diagnostic information, or a combination thereof. According to one embodiment, health sensor modalities 107, may include but are not limited to: illuminated magnified optics, frequency data collector, fluids collector, sine-wave collector, thermo collector, respiratory collector, or modular wired adapters for modality appliances (see FIG. 6). In combination with the multi-modality device 103, these modular adapters present a powerful tool for health sensor collection. For example, the HP 101 may detect that a diabetic patient's blood sugar level is outside of the healthy range for the patient. Based on this data, the HP 101 may automatically prompt the diabetic patient to measure his temperature using the thermo collector modality 107 to see if the hyperglycemia is due to a cold or flu.

In step 503, the HP 101 creates a patient health record based on the one or more modalities of the health sensor data. The patient health record may be as simple as a history of collected sensor health data. Collected health sensor data may include measurements (temperatures, oxygenated blood, blood pressure, blood sugar levels, etc.), images (both external and internal), recorded sounds (coughs, heartbeats, breathing, etc.), and videos (patients demonstrating painful range of motions, clinicians demonstrating how to self-administer treatments, etc.) Additionally, the patient health record may also contain information such as detailed health history, current vital statistics, family health history, associated devices, IP address, phone number, list of clinicians, health insurance information, etc. In one embodiment, the HP 101 may aggregate the collection of patient health records to search trends in health data according to variables such as age, location, sex, income, education, etc. That is, these patient health records may populate clinical health data records.

In step 505, the HP 101 provides a remote control of the multi-modality device by the second party over the communication session. In one embodiment, the second party (e.g., a clinician) may remotely control the multi-modality device 103. For example, for a first party (e.g., patient) with an earache, the clinician may instruct the patient to form multi-modality device 103, which may consist of a camera lens. The clinician may instruct the patient to aim the camera into his ear and direct the patient to aim the camera at various locations in the ear. The clinician may then remotely push a local button which may control the patient's camera to capture and store photos near the entrance of the patient's ear canal.

FIG. 6 is a diagram of an embodiment of a multi-modality core device and possible options for modalities, according to one embodiment. In this embodiment, the multi-modality device 103's core is a central controlling hand piece 601. The central controlling hand piece 601 may be a small, lightweight, piece with modality adaptability, removable storage, on board storage, on board energy, external energy interface, and communication adaptability. The modality adaptability of the central controlling hand piece 601 allows this embodiment of device 103 to combine with multiple removable adapters 603-617 for varying ergonomic and/or clinical modalities such as: illuminated magnified optics adapter 603, frequency data collector 605, fluids collector 607, sine-wave collector 609, thermo collector 611, respiratory collector 613, or modular wired adapters for modality appliances 615-617. Additionally, the modality adaptability of the central controlling hand piece 601 also allows for removable adapters for varying ergonomic and/or communication interfaces 619-627, such as: wired 619, ⅛ phone 621, cellular/satellite/telematics 623, near field wireless 625, and 802.11(x) 627.

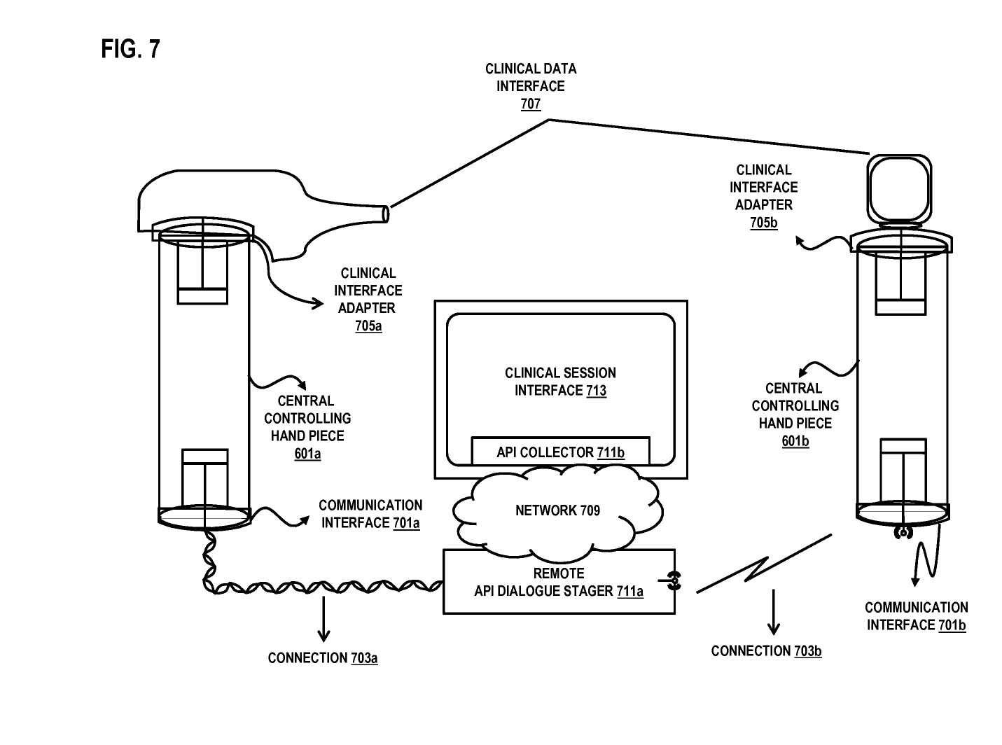

FIG. 7 is a diagram of an implementation of the central controlling hand piece engaged in a communication session with a second party, according to one embodiment. The central controlling hand piece 601a represents the device 103 associated with a first party. The central controlling hand piece 601b is the device 103 associated with a second party. The central controlling hand piece 601a is connected via a wired connection 703a via communication interface 701a. The central controlling hand piece 601b is connected via communication interface 701b wirelessly via the connection 703b. The clinical interface adapter 705a may represent one of the clinical interfaces 603-617 while the clinical interface adapter 705b may be any interface collector. The clinical data interface 707 is an example of clinical data interface modalities. The remote API stager 711a and API collector 711b represent the communication API's within network 709. The clinical session interface 713 may provide the users of the respective central controlling hand pieces 601a and 601b a front-end interactive interface for the communication session. The clinical session interface 713 may display live video of the respective parties in real time (e.g., teleconference). The clinical session interface may also display health charts, the user interface for the status of any modality in use, explanatory images, videos, and text as selected by the clinician or patient for viewing.

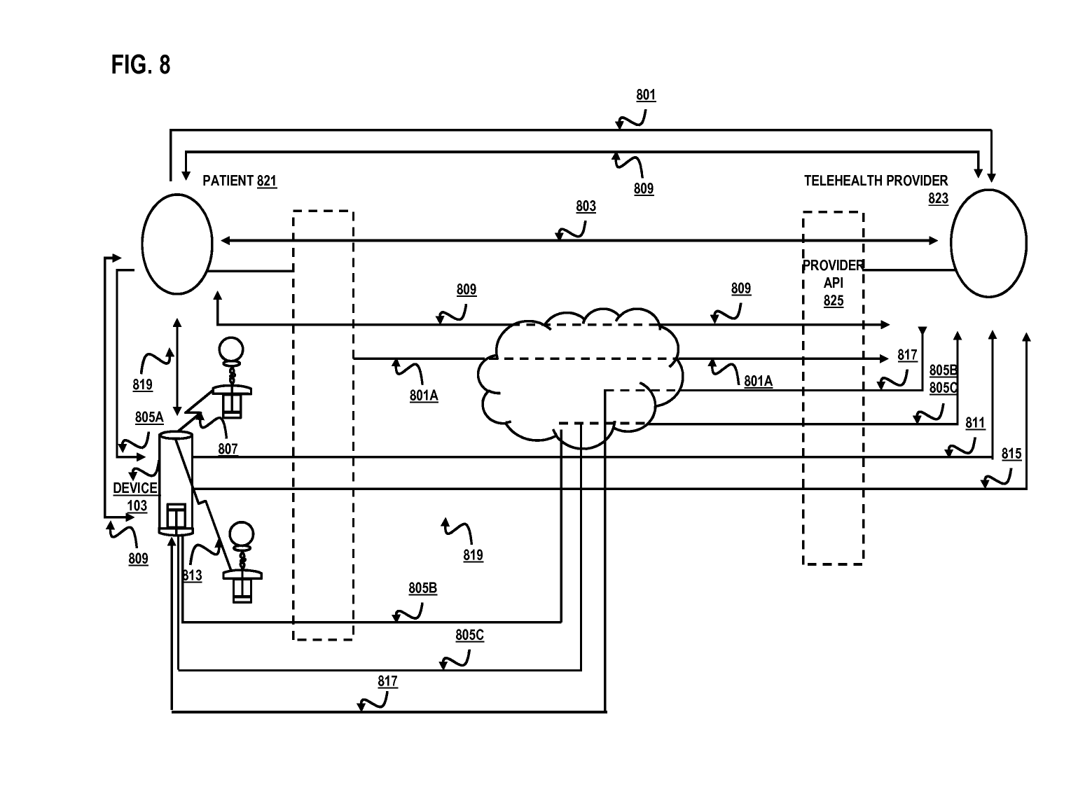

FIG. 8 is a diagram for an example workflow using the multi-modality device during a communication session, according to one embodiment. For example, one using the device 103 may participate in a communication session. In step 801, the patient 821 may connect with a telehealth provider 823 outside of a provider 823's application programming interface (API) 825. In step 801a, the patient 821 may connect with a telehealth provider 823 via a provider's API 825. In step 803, the patient 821 may engage in the clinical session with the clinician. During the session the clinician 823 may insist on additional clinical finding for the diagnoses. When requested by the clinician 823, the patient 821 may connect the device 103 on one end to a communications interface or computing device. That is, in step 805a, the patient 823 may assemble the device 103 to communicate with the clinician 823. In step 805b, the patient 821 may prepare the device 103 for the session via the provider's API 825. In step 805c, the patient 821 may prepare the device 103 for the session external of the provider's API 825. Likewise, the patient 821 may connect the device 103 to an appropriate clinical interface adapter 107 on the other (step 807). The patient 821 may use the device 103 in such a way as instructed by the remote clinician 823 to focus on an area of clinical interest (step 809). The data from the device 103 may be sent to the remote clinician 823 for review (step 811). A clinician 823 may value and interpret the findings. During these initial findings the remote clinician 823 may instruct the patient 821 on best practice in using the device 103 or ask that she exchange the active interface adapter for another which may offer additional clarity on patient presentation (step 813). The process may continue until a course of action can be determined (step 815). The provider 823 may send data to the device 103 to further interact with the patient 821 (step 817). When additional clinical data samples are requested of the patient 821, the device 103 may be used to capture the data asynchronously of the communication session and that collected data may be stored by the device 103 for later sharing and review (step 819).

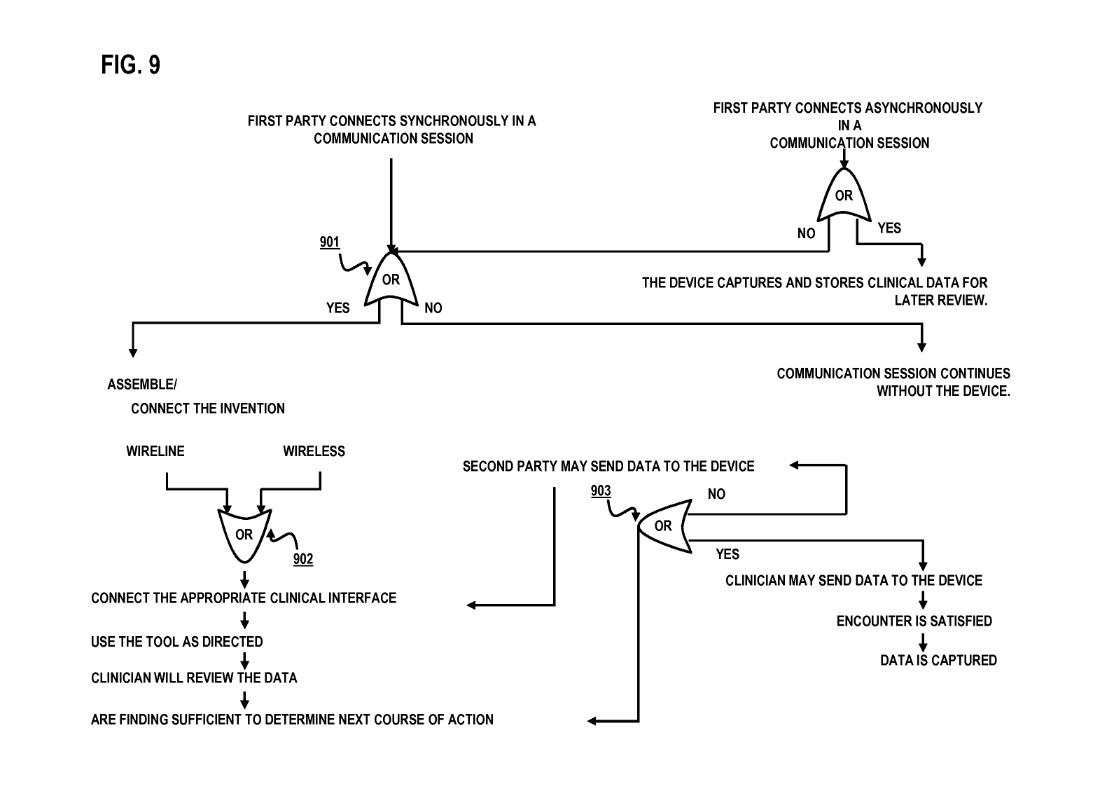

FIG. 9 is a flow chart for an implementation of the use of the multi-modality device during a communication session, according to one embodiment. At step 901, the first question to be answered is if used synchronously or asynchronously in a communication session; does the session require the device 103? If the answer is no, the communication session continues without the device 103 until the next course of action is determined. If the answer is yes for the asynchronous communication session, the device 103 captures and stores the clinical data for later review. If the answer is yes for the synchronous communication session, the patient must assemble and connect the device either via a wireline or wirelessly (step 902). Once connected, the user may connect the appropriate clinical interface. At step 903, the next question is whether the clinician may send data to the device 103. If the second party may not send data to the device, the communication session ends. If the second party may send data to the device, the first party may proceed by using the tool as directed; the second party may review the data and determine if findings are sufficient to determine the next course of action. If the findings are not sufficient, the process repeats starting with whether the second party may send data to the device. If the findings are sufficient, the clinician may send additional data to the device, satisfying the session and capturing the data.

FIG. 10 is an image of a sample implementation of a multi-modality device, according to one embodiment. The multi-modality device 103 may be any hand-held portable device capable of a portable energy source, removable storage, local storage, external energy interface, communication, and modality adaptability. In an exemplary embodiment, the multi-modality device may be a lightweight device that can be held and controlled with only one hand with a communication interface 1001 on one end and a clinical modality interface 1003 on the other end.

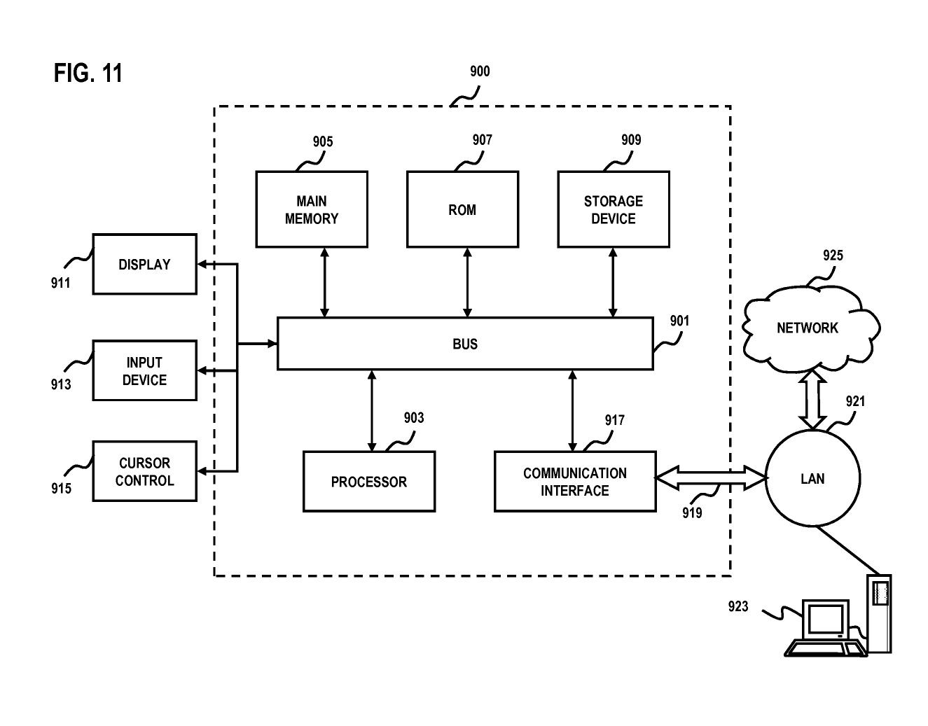

FIG. 11 is a diagram of a computer system that can be used to implement various exemplary embodiments. The computer system 1100 may be coupled via the bus 1101 to a display 1111, such as a cathode ray tube (CRT), liquid crystal display, active matrix display, or plasma display, for displaying information to a computer user. An input device 1113, such as a keyboard including alphanumeric and other keys, is coupled to the bus 1101 for communicating information and command selections to the processor 1103. Another type of user input device is a cursor control 1115, such as a mouse, a trackball, or cursor direction keys, for communicating direction information and command selections to the processor 1103 and for controlling cursor movement on the display 1111.

According to an embodiment of the device 103, the processes described herein are performed by the computer system 1100, in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the device 103. Thus, embodiments of the device 103 are not limited to any specific combination of hardware circuitry and software.

The computer system 1100 also includes a communication interface 1117 coupled to bus 1101. The communication interface 1117 provides a two-way data communication coupling to a network link 1119 connected to a local network 1121. For example, the communication interface 1117 may be a digital subscriber line (DSL) card or modem, an ISDN card, a cable modem, a telephone modem, or any other communication interface to provide a data communication connection to a corresponding type of communication line. As another example, communication interface 1117 may be a LAN card (e.g. for Ethernet™ or an Asynchronous Transfer Model (ATM) network) to provide a data communication connection to a compatible LAN. Wireless links can also be implemented. In any such implementation, communication interface 1117 sends and receives electrical, electromagnetic, or optical signals that carry digital data streams representing various types of information. Further, the communication interface 1117 can include peripheral interface devices, such as a Universal Serial Bus (USB) interface, a PCMCIA (Personal Computer Memory Card International Association) interface, etc. Although a single communication interface 1117 is depicted in FIG. 11, multiple communication interfaces can also be employed.

The network link 1119 typically provides data communication through one or more networks to other data devices. For example, the network link 1119 may provide a connection through local network 1121 to a host computer 1123, which has connectivity to a network 1125 (e.g. a WAN or the global packet data communication network now commonly referred to as the “Internet”) or to data equipment operated by a service provider. The local network 1121 and the network 1125 both use electrical, electromagnetic, or optical signals to convey information and instructions. The signals through the various networks and the signals on the network link 1119 and through the communication interface 1117, which communicate digital data with the computer system 1100, are exemplary forms of carrier waves bearing the information and instructions.

The computer system 1100 can send messages and receive data, including program code, through the network(s), the network link 1119, and the communication interface 1117. In the Internet example, a server (not shown) might transmit requested code belonging to an application program for implementing an embodiment of the device 103 through the network 1125, the local network 1121 and the communication interface 1117. The processor 1103 may execute the transmitted code while being received and/or store the code in the storage device 1109, or other non-volatile storage for later execution. In this manner, the computer system 1100 may obtain application code in the form of a carrier wave.

The term “computer-readable medium” as used herein refers to any medium that participates in providing instructions to the processor 1103 for execution. Such a medium may take many forms, including but not limited to non-volatile media, volatile media, and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the device 103 may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a PDA or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 12 illustrates a chip set 1200 upon which an embodiment of the device 103 and/or HP 101 may be implemented. Chip set 1200 is programmed to present a slideshow as described herein and includes, for instance, the processor and memory components described with respect to FIG. 12 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1200, or a portion thereof, constitutes a means for performing one or more steps of FIGS. 3-5.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1205 also stores the data associated with or generated by the execution of the inventive steps.

While certain exemplary embodiments and implementations have been described herein, other embodiments and modifications will be apparent from this description. Accordingly, the device 103 or HP 101 is not limited to such embodiments, but rather to the broader scope of the presented claims and various obvious modifications and equivalent arrangements.

What is claimed is:

1. A method comprising:
providing an abstraction layer for a processing, a collection, or a combination thereof of one or more modalities of health sensor data sensed by a multi-modality device associated at a first party; and
initiating a communication session between the multi-modality device associated and a device associated with a second party for transmitting the health sensor data, selecting the one or more modalities, configuring the multi-modality device to support the one or more modalities, providing health diagnostic information based on the health sensor data, or a combination thereof.

2. A method of claim 1, wherein the multi-modality device comprises a core device with a first interface for supporting one or more clinical modular adapters associated respectively with the one or more modalities.

3. A method of claim 2, wherein the core device includes a second interface for supporting one or more communication modules for initiating the communication session.

4. A method of claim 2, further comprising:
retrieving profile information associated with the first party, the second party, or a combination thereof; and
configuring or providing instructions for configuring the first interface, the second interface, or a combination thereof based on the profile information.

5. A method of claim 1, further comprising:
configuring the multi-modality device for an asynchronous mode of operation,
wherein the asynchronous mode of operation causes the multi-modality device to locally store the one or more modalities of the health sensor data before initiating the communication session for a batch transmission.

6. A method of claim 1, further comprising:
determining one or more other modalities of the health sensor data to collect from the multi-modality device based on the collected one or more modalities, the health diagnostic information, or a combination thereof.

7. A method of claim 1, further comprising:
creating a patient health record based on the one or more modalities of the health sensor data.

8. A method of claim 1, further comprising:
providing a remote control of the multi-modality device by the second party over the communication session.

9. A method of claim 1, wherein the first party is a patient and the second party is a clinician.

10. An apparatus comprising a processor configured to:
provide an abstraction layer for a processing, a collection, or a combination thereof of one or more modalities of health sensor data sensed by a multi-modality device associated a first party; and
initiate a communication session between the multi-modality device associated and a device associated with a second party for transmitting the health sensor data, selecting the one or more modalities, configuring the multi-modality device to support the one or more modalities, providing health diagnostic information based on the health sensor data, or a combination thereof.

11. An apparatus of claim 10, wherein the multi-modality device comprises a core device with a first interface for supporting one or more clinical modular adapters associated respectively with the one or more modalities.

12. An apparatus of claim 11, wherein the core device includes a second interface for supporting one or more communication modules for initiating the communication session.

13. An apparatus of claim 11, further comprising:
retrieve profile information associated with the first party, the second party, or a combination thereof; and
configure or providing instructions for configuring the first interface, the second interface, or a combination thereof based on the profile information.

14. A apparatus of claim 10, further comprising:
configure the multi-modality device for an asynchronous mode of operation,
wherein the asynchronous mode of operation causes the multi-modality device to locally store the one or more modalities of the health sensor data before initiating the communication session for a batch transmission.

15. An apparatus of claim 10, further comprising:
determine one or more other modalities of the health sensor data to collect from the multi-modality device based on the collected one or more modalities, the health diagnostic information, or a combination thereof.

16. An apparatus of claim 10, further comprising:
create a patient health record based on the one or more modalities of the health sensor data.

17. An apparatus of claim 10, further comprising:
provide a remote control of the multi-modality device by the second party over the communication session.

18. An apparatus of claim 10, wherein the first party is a patient and the second party is a clinician.

19. A system comprising a platform configured to:
provide an abstraction layer for a processing, a collection, or a combination thereof of one or more modalities of health sensor data sensed by a multi-modality device associated a first party; and
initiate a communication session between the multi-modality device associated and a device associated with a second party for transmitting the health sensor data, selecting the one or more modalities, configuring the multi-modality device to support the one or more modalities, providing health diagnostic information based on the health sensor data, or a combination thereof.

20. A system of claim 19, wherein the core device includes a second interface for supporting one or more communication modules for initiating the communication session and the core device includes a second interface for supporting one or more communication modules for initiating the communication session.
